(19) United States
(12) Patent Application Publication
(10) Pub. No.: US 2002/0163251 A1
(43) Pub. Date: Nov. 7, 2002

(54) Regenerative brake system architecture for an electric or hybrid electric vehicle

(76) Inventors: Dale Scott Crombez, Livonia, MI (US); Patrick J. Curran, Northville, MI (US); Steven Lee Napier, Canton, MI (US)

Correspondence Address: DYKEMA GOSSETT PLLC, 39577 WOODWARD AVENUE, SUITE 300, BLOOMFIELD HILLS, MI, 48304, US

(21) Appl. No.: 09/850,354

(22) Filed: May 7, 2001

(51) Int. Cl. B60T 8/64; B60L 7/10

(52) U.S. Cl. 303/152; 188/159

(57) ABSTRACT

An electric or hybrid electric vehicle 7 is provided which includes a first wheeled axle 10 that is electrically driven and has only electric regenerative brakes. The vehicle 7 also includes a second wheeled axle (22, 32, 44) that has only friction brakes 26. The cost and complexity of friction brakes on the second axle (22, 32, 44) can be avoided.

### FIELD OF THE INVENTION

The field of the present invention is that of electric vehicles and/or hybrid electric vehicles. Specifically, the present invention relates to regenerative brake system architecture for an electric or hybrid electric vehicle and a method of control thereof.

### BACKGROUND OF THE INVENTION

The need to reduce fossil fuel consumption and emissions in automobiles and other vehicles predominantly powered by an internal combustion engine (ICE) is well known. Vehicles powered by electric motors attempt to address this need. An alternative solution is to combine a smaller ICE with an electric motor into one vehicle. Such a vehicle, typically called a hybrid electric vehicle (HEV), combines the advantage of an ICE vehicle and an electric vehicle. See generally, Severinsky, U.S. Pat. No. 5,343,970.

Vehicles driven by electric motors not only provide opportunities to conserve energy, but such vehicles also provide opportunities for energy regeneration. Many electric vehicles and HEVs have electric regenerative brakes. The kinetic energy that an electric or HEV dissipates during braking, or any other period in which the accelerator pedal is not depressed while the vehicle is in motion, e.g. coasting, can advantageously be regenerated. Such regeneration can be accomplished by controlling the electric motor so that it operates as a generator. The kinetic energy received during this process can be used to recharge the battery and is stored for future use. Typically, regenerative brakes are designed to control deceleration of the vehicle with a combination of friction braking and regenerative braking. Typical vehicle configurations overlay the conventional brake configuration with the regenerative braking scheme. Accordingly, there typically is a conventional hydraulic friction brake system for all four wheels of the vehicle. Patents discussing these and other issues related to battery operation include U.S. Pat. Nos. 3,774,095; 5,472,264; 5,492,192; 5,683,322; 5,707,115; 5,853,229; and 5,890,982.

To bestow the maximum benefit which can be provided by an electric or HEV to the greatest amount of people, it is desirable that, wherever possible, components be eliminated to accordingly lower the cost of such vehicles. It is desirable to provide an electric or HEV that can eliminate the requirement for hydraulic braking on at least one axle.

### SUMMARY OF THE INVENTION

To make manifest the above delineated and other manifold desires, a revelation of the present invention is brought forth. A preferred embodiment of the present invention has a first wheeled axle which is driven by an electric motor. The electric motor also functions as a generator to provide for regenerative braking. The second wheeled axle of the present invention can be unpowered, powered by an ICE or alternatively, powered by an ICE and a second motor combination. The configuration of the vehicle of the present invention allows for optimization of the regenerative braking such that on tip-out of the accelerator, the first electric motor provides (compression) regenerative braking on its respective wheeled axle to slow the vehicle, while at the same time sending energy to the battery. If the vehicle operator commands a braking operation, the first electric motor continues to provide braking (referred to as service braking) to its respective wheeled axle up to a regenerative limit. Additional braking required to slow or stop the vehicle is then provided by the friction braking on the second wheeled axle. If the second wheeled axle is powered by an ICE or by an ICE second motor combination, compression braking by the ICE can additionally occur upon the other wheeled axle. A feature of the present invention is that there are no friction service brakes on the first wheeled axle.

The vehicle configuration of the present invention serves to reduce vehicle brake system complexity and weight and can be utilized whether the first wheeled axle is the front or the rear axle of the vehicle.

It is an advantage of the present invention to provide an electric or HEV which only requires conventional friction brakes on one axle of the vehicle.

Other advantages of the present invention will become more apparent to those persons having ordinary skill in the art to which the present invention pertains from the following description taken in conjunction with the accompanying drawings.

### BRIEF DESCRIPTION OF THE DRAWINGS

FIG. 1 is a schematic view of a preferred embodiment electric vehicle of the present invention.

FIG. 2 is a schematic view similar to that of FIG. 1 of an alternate preferred embodiment electric vehicle having an internal combustion engine on the axle which is not driven or braked by the motor generator.

FIG. 3 is another schematic view similar to FIGS. 1 and 2 of an alternate preferred embodiment of the present invention having a motor generator on a first axle and a hybrid combination of an internal combustion engine and motor generator on a second axle.

FIG. 4 is a schematic view of the power train on the friction brake axle shown in FIG. 3 illustrating the layout of the internal combustion engine, the motor generator, planetary gear transmission and portions of the power train.

FIG. 5 is a schematic view of the planetary gear transmission shown in FIG. 4.

FIG. 6 is a flow chart illustrating a braking regime of the regenerative braking utilized on an inventive vehicle as shown in FIGS. 1 through 3.

### DETAILED DESCRIPTION OF THE INVENTION

Referring to FIG. 1, an electric vehicle 7 has a body (not shown) mounted on a first wheeled axle 10. The wheeled axle 10 is powered by a motor generator 14. The motor generator may be transversely aligned with the vehicle as shown, however, the present invention does not require that the motor generator 14 be aligned with a rotational axis of the axle. The motor generator 14 can be longitudinally aligned with the major axis of the vehicle or may be torsionally connected with the axle 10 via a gearing arrangement (not shown) The motor generator 14 powers the a wheeled axle 10, which in turn, turns wheels 14 through a differential and half-shaft arrangement (not shown). Vehicle 7 additionally has a second wheeled axle 22. Wheeled axle 22 is undriven. Wheeled axle 22 is connected to wheels 24. Since the axle 22 is undriven, a differential for the second axle 22 will typically not be required.

The vehicle shown in FIG. 1 has electric regenerative brakes on the first axle 10. The second axle 22 has hydraulic powered friction brakes 26. The first wheeled axle 10 may serve as the front or the rear axle of the vehicle 7. When serving as the rear axle of the vehicle, the configuration of FIG. 1 provides an additional advantage of placing more weight on the rear axle. Maximum braking capacity is a direct function of the weight on a given axle. Therefore more weight on the rear axle enhances the regenerative braking capabilities. The motor generator 14 is electrically connected with a battery 28, which will located to take advantage of the space envelope available in the vehicle, as well as the weight distribution for the axles of the vehicle.

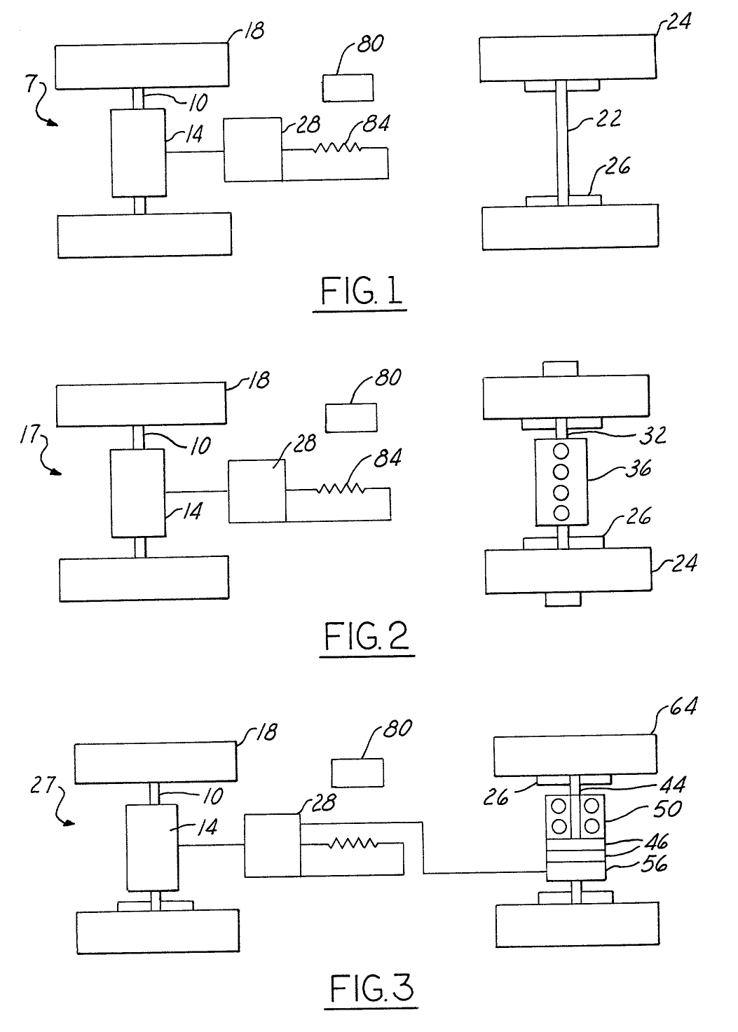

Referring to FIG. 2, with like items being given identical reference numerals, a hybrid electric vehicle 17 has a first wheeled axle 10. The first axle 10 in the remainder of its characteristics is similar or identical to the first axle 10 of vehicle 7. The second axle 32 is powered by an internal combustion engine 36. The internal combustion engine may be a transverse mounted engine or an engine which is aligned with the major axis of the vehicle 17. The engine 36 will typically be torsionally connected with the second axle 32 via a differential and gear set (not shown) as is conventional in the art. Again, the second axle 32 has hydraulic powered or optional electric powered friction brakes 26.

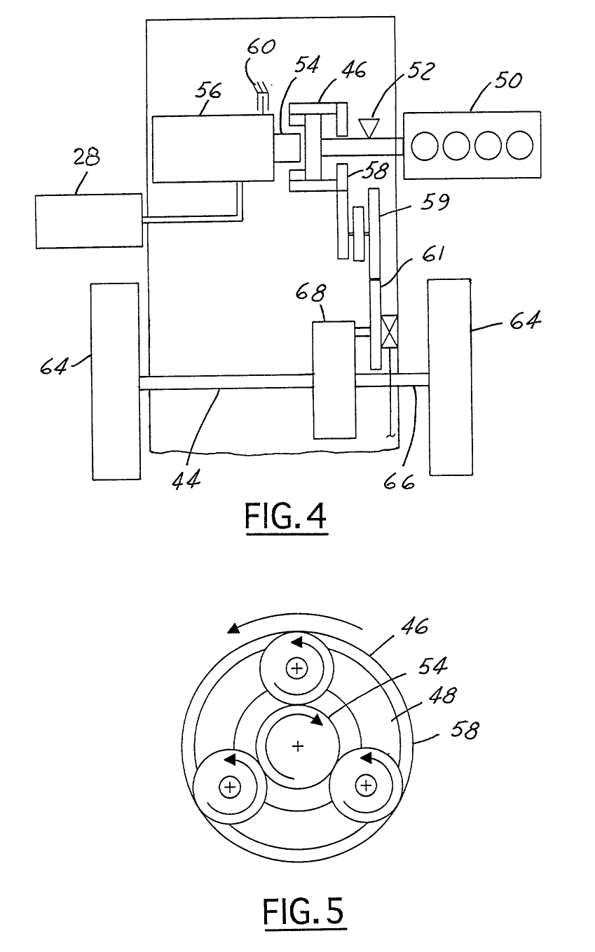

FIG. 3 illustrates a hybrid electric vehicle 27. The second wheeled axle 44 has a parallel-series HEV power-split configuration. Referring also to FIGS. 4-5, a planetary gear set 46 mechanically couples a gear carrier 48 to an internal combustion engine 50 via a one-way clutch 52. The planetary gear set 46 also mechanically couples a sun gear 54 to a second motor generator 56 and to a ring gear (output) 58. The motor generator 56 also mechanically links to a generator brake 60 and is electrically linked to a battery 28. The ring gear 58 is mechanically coupled to the drive wheels 64 via output half-shafts 66. Half-shafts 66 are coupled with a differential 68 which is gearably connected with the ring gear 58.

The planetary gear set 46 splits the engine 50 output energy into a series path from the engine 50 to the generator motor 56 and a parallel path from the engine 50 to the drive wheels 64. The speed of engine 50 can be controlled by varying the split to the series path while maintaining the mechanical connection through the parallel path.

The vehicle 27 has a first wheeled axle 10. The first wheeled axle 10 is driven by a motor generator 14. The motor generator 14 electrically powers the first wheeled axle 10. The motor generator 14 also can brake the first wheeled axle 10 by electric regenerative braking. The motor generator 14 is electrically connected with the battery 28.

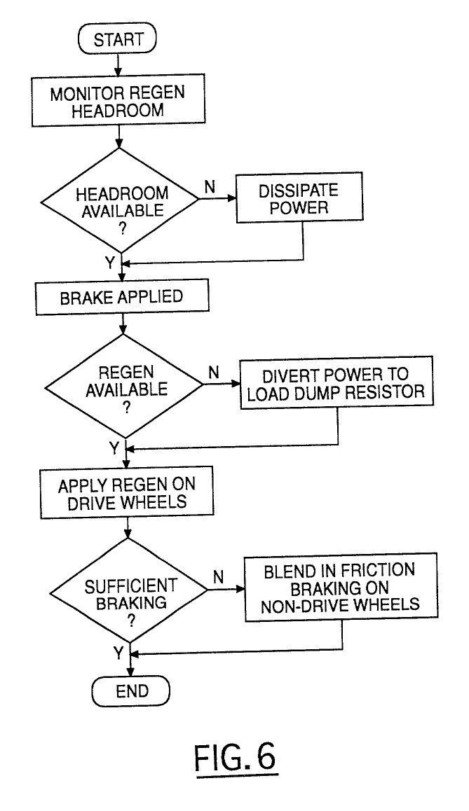

Referring additionally to FIG. 6 and referring back to FIG. 1, when a vehicle operator of vehicle 7 lifts their foot off the accelerator, regenerative braking is performed by the motor generator 14 on the first axle 10. The regenerative braking will occur up to a first level on axle 10. If the vehicle operator desires a greater second level of braking, the hydraulically or electrically actuated friction brakes 26 braking torque will be blended into the second axle 22. A controller 80 will continuously monitor the regenerative braking headroom available. If battery 28 is charged beyond a predefined level, there will be no regenerative braking headroom. If the regenerative braking headroom is not available, controller 80 will signal the battery to dissipate power through a thermal load resistor 84 to ensure that regenerative braking is at all times available.

Referring to the vehicle 17 shown in FIG. 2, when an operator's foot is lifted off the accelerator, regenerative braking will occur via the motor generator 14. Additionally, compression braking will occur with the internal combustion engine 36. If the regenerative braking by the motor 14 and the compression braking by internal combustion engine 36 are not sufficient, additional braking will be blended in via the friction brakes 26 in the manner afore described. Again, regenerative headroom is monitored in the manner described for vehicle 7.

Referring back to FIG. 3, when the operator's foot is lifted off the accelerator, regenerative braking will occur by motor 14 and by internal combustion engine 50. Regenerative braking headroom of motor 14 will be monitored as aforedescribed. Vehicle 27 provides an advantage in that the battery 28 can be recharged not only by the regenerative braking of motor 14, but also by the internal combustion engine powering the motor generator 56 in the manner aforedescribed.

While preferred embodiments of the present invention have been disclosed, it is to the understood that they have been disclosed by way of example only and that various modifications can be made without departing from the spirit and scope of the invention as it is encompassed by the following claims.

We claim:

1. An electric vehicle comprising:
a first wheeled axle electrically driven with only electric regenerative brakes;
a second wheeled axle, non-driven and with only friction brakes.

2. An electric vehicle as described in claim 1, wherein said first wheeled axle is a front axle.

3. An electric vehicle as described in claim 1, wherein said first wheeled axle is a rear axle.

4. A method of braking an electric vehicle which has a first wheeled axle electrically driven with electric regenerative brakes and a second wheeled axle which is non-driven and with only friction brakes, said method comprising:
electrically regeneratively braking said first axle to a first level; and
frictionally braking said second axle to provide a braking force upon said vehicle greater than said electric regenerative braking.

5. A method of braking an electric vehicle as described in claim 4, further comprising:
sensing the headroom available for regeneratively braking said vehicle; and
dissipating power to provide additional regenerative braking for said vehicle.

6. A method of braking a vehicle as described in claim 5, wherein said dissipating power is through a thermal resistor.

7. A vehicle comprising:
a first wheeled axle electrically driven with only electric regenerative brakes; and
a second wheeled axle driven by an internal combustion engine with only friction brakes.

8. An electric vehicle as described in claim 7, wherein said internal combustion engine can additionally compression brake said second wheeled axle.

9. A vehicle as described in claim 7, wherein said first wheeled axle is a front axle.

10. A vehicle as described in claim 7, wherein said first wheeled axle is a rear axle.

11. A vehicle as described in claim 7, additionally having a secondary electric motor generator for powering said second wheeled axle.

12. A method of braking a vehicle having a first wheeled axle electrically driven with only electric regenerative brakes and a second wheeled axle driven by an internal combustion engine with friction brakes, said method comprising:
electrically regeneratively braking said first wheeled axle up to a first level; and
frictionally braking said second wheeled axle when said braking requirement of said vehicle is above said first level.

13. A method of braking a vehicle as described in claim 12, additionally comprising compression braking said first wheeled axle with said internal combustion engine up to said first level and above said first level of braking said vehicle.

14. A method as described in claim 12, additionally comprising the steps of monitoring the headroom of regenerative braking available and dissipating power to make more headroom available for regenerative braking.

15. A method of braking a vehicle as described in claim 14, wherein said method of dissipating power is through a thermal resistor.
